(19) United States
(12) Patent Application Publication
(10) Pub. No.: US 2025/0093573 A1
(43) Pub. Date: Mar. 20, 2025

(54) LOCALLY ANTIREFLECTION-COATED SPLIT PUPIL INPUT COUPLERS FOR MULTISHEET DIFFRACTIVE WAVEGUIDES

(71) Applicant: Applied Materials, Inc., Santa Clara, CA (US)

(72) Inventors: Simon LORENZO, Santa Clara, CA (US); Evan WANG, Palo Alto, CA (US); Kunal SHASTRI, Santa Clara, CA (US); Samarth BHARGAVA, Saratoga, CA (US)

(21) Appl. No.: 18/885,271

(22) Filed: Sep. 13, 2024

Related U.S. Application Data
(60) Provisional application No. 63/538,653, filed on Sep. 15, 2023.

(51) Int. Cl. F21V 8/00; G02B 1/11

(52) U.S. Cl. CPC G02B 6/0076; G02B 1/11; G02B 6/0016; G02B 6/0026

(57) ABSTRACT

A method and apparatus for a device including a first waveguide, the first waveguide having a first input coupler operable to receive a first color light and in-couple the first color light into the first waveguide, and a coating area adjacent to a grating of the first input coupler, the coating area operable to receive a second color light, the coating area having an anti-reflective coating with a transmission refractive index such that in operation the second color light is transmitted through the first waveguide to a second waveguide, the second waveguide below the first waveguide, the second waveguide having a second input coupler disposed below and aligned with the coating area, the second input coupler operable to receive the second color light and in-couple the second color light into the second waveguide.

### CROSS-REFERENCE TO RELATED APPLICATIONS

This application claims benefit of U.S. provisional patent application Ser. No. 63/538,653, filed Sep. 15, 2023, which is herein incorporated by reference.

### BACKGROUND

### Field

Embodiments of the present disclosure generally relate to augmented reality waveguides. More specifically, embodiments described herein relate to waveguides with split input couplers having local anti-reflective coatings.

### Description of the Related Art

Virtual reality is generally a computer generated simulated environment in which a user has an apparent physical presence. A virtual reality experience may be generated from a three-dimensional (3D) perspective and viewed with a head-mounted display (HMD), such as glasses or other wearable display devices that have near-eye display panels as lenses to display a virtual reality environment that substantially replaces an actual environment.

Augmented reality (AR) enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

One such challenge is displaying a virtual image overlaid on an ambient environment. Waveguide combiners are used to assist in overlaying images. Generated light is in-coupled into a waveguide combiner, propagated through the augmented waveguide combiner, out-coupled from the augmented waveguide combiner, and overlaid on the ambient environment. Light is coupled into and out of augmented waveguide combiners using surface relief gratings.

Accordingly, what is needed in the art are waveguide combiners having split input couplers that effectively transmit incident light.

### SUMMARY

The present disclosure generally includes a device. The device may include a first waveguide, the first waveguide having a first input coupler operable to receive a first color light and in-couple the first color light into the first waveguide. The device may include a coating area adjacent to a grating of the first input coupler, the coating area operable to receive a second color light, the coating area having an anti-reflective coating with a transmission refractive index such that in operation the second color light is transmitted through the first waveguide to a second waveguide. The device may include the second waveguide below the first waveguide, the second waveguide having a second input coupler disposed below and aligned with the coating area, the second input coupler operable to receive the second color light and in-couple the second color light into the second waveguide.

The present disclosure generally includes a device. The device may include a first waveguide, the first waveguide having a first input coupler operable to receive a first color light and in-couple the first color light into the first waveguide, and a first coating area adjacent to a first grating of the first input coupler, the first coating area operable to receive a second color light and a third color of light, the first coating area having a first anti-reflective coating with a first transmission refractive index such that in operation the second color light is transmitted through the first waveguide to a second waveguide, and the first coating area having a second anti-reflective coating with a second transmission refractive index such that in operation the third color light is transmitted through the first waveguide to a second waveguide. The device may include a second waveguide, the second waveguide having a second input coupler operable to receive the second color light and in-couple the second color light into the second waveguide, and a second coating area adjacent to a second grating of the second input coupler, the second coating area operable to receive the third color light, the second coating area having a third anti-reflective coating with a third transmission refractive index such that in operation the third color light is transmitted through the second waveguide to a third waveguide. The device may include the third waveguide below the second waveguide, the third waveguide having a third input coupler disposed below and aligned with the second coating area, the third input coupler operable to receive the third color light and in-couple the third color light into the third waveguide.

The present disclosure generally includes method for forming a device. The method may include in-coupling a first color light into a first waveguide, the first waveguide having a first input coupler operable to receive the first color light, and receiving a second color light at a coating area adjacent to a grating of the first input coupler, the coating area having an anti-reflective coating with a transmission refractive index such that in operation the second color light is transmitted through the first waveguide to a second waveguide, the second waveguide below the first waveguide, the second waveguide having a second input coupler disposed below and aligned with the coating area, the second input coupler operable to receive the second color light and in-couple the second color light into the second waveguide.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is an example schematic view of a waveguide, according to embodiments.

FIG. 2 is an example schematic view of a waveguide, according to embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure generally relates to augmented reality waveguides. More specifically, embodiments described herein relate to waveguides with split input couplers having local anti-reflective coatings.

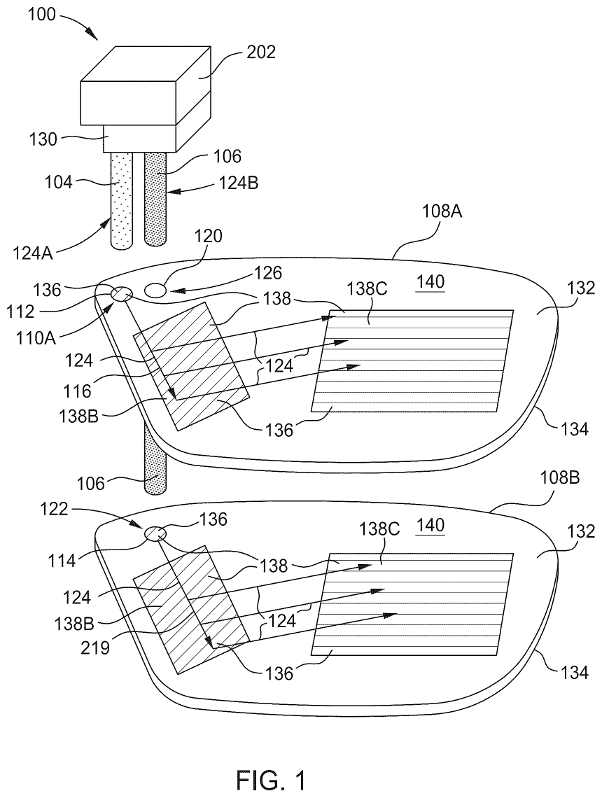

FIG. 1 is a device 100. Device 100 has a light engine 102, a first incident light trajectory 104, a second incident light trajectory 106, a first waveguide 108A, a second waveguide 108B, a first input coupler 112, a second input coupler 114, a first transmitted light trajectory 116, a second transmitted light trajectory 118, and a local anti-reflective coating 120. The device 100 includes the first waveguide 108A and the second waveguide 108B. It is to be understood that each waveguide (e.g., the first waveguide 108A and the second waveguide 108B) described herein is an exemplary waveguide and that other waveguides may be used with or modified to accomplish aspects of the present disclosure. Each waveguide (e.g., the first waveguide 108A and the second waveguide 108B) may be a waveguide layer. In certain embodiments, a waveguide combiner is formed from the waveguide layers. Each waveguide (e.g., the first waveguide 108A and the second waveguide 108B) includes a plurality of structures 136. The structures 136 may be disposed over, under, or on a first surface 132 or a second surface 134 of a substrate 140, or disposed in the substrate 140. The structures 136 are nanostructures that have a sub-micron critical dimension (e.g., less than 1 micrometer). Regions of the structures 136 correspond to one or more gratings 138. In one embodiment, which can be combined with other embodiments described herein, each waveguide (e.g., the first waveguide 108A and the second waveguide 108B) includes at least an input coupler (e.g., the first input coupler 112 or the second input coupler 114) (e.g., an input coupler grating), an output coupler 138C (e.g., an out coupler grating), and an intermediate grating 138B (e.g., a pupil expander or fold grating). Alternatively or additionally, the device 100 includes the structures 136 disposed on one waveguide (e.g., the first waveguide 108A or the second waveguide 108B)

In operation, the input coupler (e.g., the first input coupler 112 or the second input coupler 114) receives incident beams of light having an intensity from a light engine 102. The incident beams are split by the structures 136 into T1 beams that have all of the intensity of the incident beams in order to direct a virtual image to the intermediate grating (if utilized) or to the output coupler 138C. In one embodiment, which can be combined with other embodiments described herein, the T1 beams undergo total-internal-reflection (TIR) through the waveguide (e.g., the first waveguide 108A and the second waveguide 108B) until the T1 beams come in contact with the structures 136 of the intermediate grating. The structures 136 of the intermediate grating diffract the T1 beams to T−1 beams that undergo TIR through the waveguide (e.g., the first waveguide 108A and the second waveguide 108B) to the structures 136 of the output coupler 138C. The structures 136 of the output coupler 138C outcouple the T1 beams to the user's eye. The T1 beams outcoupled to the user's eye display the virtual image produced from the light engine from the user's perspective and further increase the viewing angle from which the user can view the virtual image. In another embodiment, which can be combined with other embodiments described herein, the T1 beams undergo total-internal-reflection (TIR) through the waveguide (e.g., the first waveguide 108A and the second waveguide 108B) until the T1 beams come in contact with the structures 136 of the output coupler 138C and are outcoupled to display the virtual image produced from the light engine.

Each waveguide (e.g., the first waveguide 108A and the second waveguide 108B) includes an input coupler (e.g., the first input coupler 112 or the second input coupler 114) operable to in-couple light into the waveguide (e.g., the first waveguide 108A and the second waveguide 108B) and an output coupler 138C. Each waveguide may be a lens or each waveguide may be disposed over or in a lens. The first input coupler 112 has a first coupler area 110 aligned with the first incident light trajectory 104. The first coupler area 110 is a surface area of the first input coupler 112. The second waveguide 108B has a second input coupler 114 with a second coupler area 122 substantially aligned with the second incident light trajectory 106. The second coupler area 122 is a surface area of the second input coupler 114. In some embodiments, which can be combined with other embodiments described herein, at least one of the waveguides (e.g., the first waveguide 108A and the second waveguide 108B) includes an intermediate grating 138B (e.g., a pupil expander).

The first waveguide 108A includes the local anti-reflective coating 120 substantially aligned with the second incident light trajectory 106. The local anti-reflective coating 120 may have a coating area 126. The coating area 126 may have variable shape, including a triangle, circle, semi-circle, square, rectangle, parallelogram, rhombus, trapezium, kite, polygon, non-geometric shape, or any other suitable shape. The coating area 126 may have variable size, though the size of coating area 126 may not exceed the size of the first waveguide 108A and may not overlap with the first input coupler 112 or the first transmitted light trajectory 116. The coating area 126 has, at a minimum, the same area and shape as the input light at the surface of the device 100.

The device 100 has a light engine 102 which includes a pupil 130 disposed above and aligned with the first input coupler 112 and the local anti-reflective coating 120. The light engine 102 is operable to project light 124 along the first incident light trajectory 104 from the pupil 130 to first waveguide 108A. The light 124 is projected at a light engine power. The light 124 is a projected image of a red light, a green light, and a blue light, i.e., white light. The light engine power is maintained at all wavelengths of the light 124. The pupil 130 projects the light 124 with an in-plane area measured at the Z-coordinate of the first input coupler 112. The in-plane area is greater than the first coupler area 110. The first input coupler 112 transmits a first portion 124A of the light 124 corresponding to the first coupler area 110 across the first waveguide 108A along a first transmitted light trajectory 116. The pupil 130 projects the light 124 with an in-plane area measured at the Z-coordinate of the local anti-reflective coating 120. The in-plane area is greater than the coating area 126. The local anti-reflective coating 120 transmits a second portion 124B of the light 124 corresponding to the coating area 126 through the first waveguide 108A along a second incident light trajectory 106 to the second waveguide 108B.

The first portion 124A of light 124 is in-coupled by the first input coupler 112 into the first waveguide 108A. The first portion 124A of light 124 is out-coupled by a first output coupler (e.g., output coupler 138C) of the first waveguide 108A. The first portion 124A of light 124 that is out-coupled is overlaid over the user's eye. The first portion 124A of light 124 includes the blue light and the green light of the projected image that is out-coupled as a blue field of view (FOV) and the green FOV the displayed image.

The device 100 has the second waveguide 108B. The second waveguide 108B includes the second input coupler 114. The second input coupler 114 has a second coupler area 122. The second coupler area 122 is a surface area of the second input coupler 114. As shown in FIG. 1 and in some embodiments, the second input coupler 114 is disposed directly below the light engine 102. In some embodiments, the second portion 124B of the light 124 that passed through the first waveguide 108A has an in-plane area measured at the Z-coordinate of the second input coupler 114 equal to the second coupler area 122. The in-plane area of the light 124 from the pupil 130 measured at the Z-coordinate of the first input coupler 112 is equal to the first coupler area 110 and the second coupler area 122 combined adjusting for any pupil (not shown) convergence or divergence.

The second portion 124B of light 124 is in-coupled by the second input coupler 114 into the second waveguide 108B. The second portion 124B of light 124 is out-coupled by a second output coupler (e.g., output coupler 138C) of the second waveguide 108B. The second portion 124B of light 124 that is out-coupled is overlaid over the user's eye. The second color light includes the red light of the projected image that is out-coupled as a red FOV of the displayed image. The blue FOV, the green FOV, and the red FOV combine to create a total FOV for the displayed image.

The first input coupler 112 is offset from the second input coupler 114 in an X-direction and a Y direction in an X-Y-Z coordinate system. The anti-reflective coating 120 has the same center point X-coordinate on an X-axis of the X-Y-Z coordinate system and center point Y-coordinate on a Y-axis of the X-Y-Z coordinate system as the second input coupler 114. The positioning of the input couplers and anti-reflective coating enables the second portion 124B of light 124 to be transmitted to the second input coupler 114 at a desired intensity.

The blue and the green FOV and the red FOV are projected having an optimized color uniformity and efficiency. In some embodiments, the device 100 is in an AR device and the blue and the green FOV and the red FOV are projected in the AR device. The blue and the green FOV and the red FOV can be combined in an image that has optimized uniformity of Red-Blue-Green (RGB) color across the FOV.

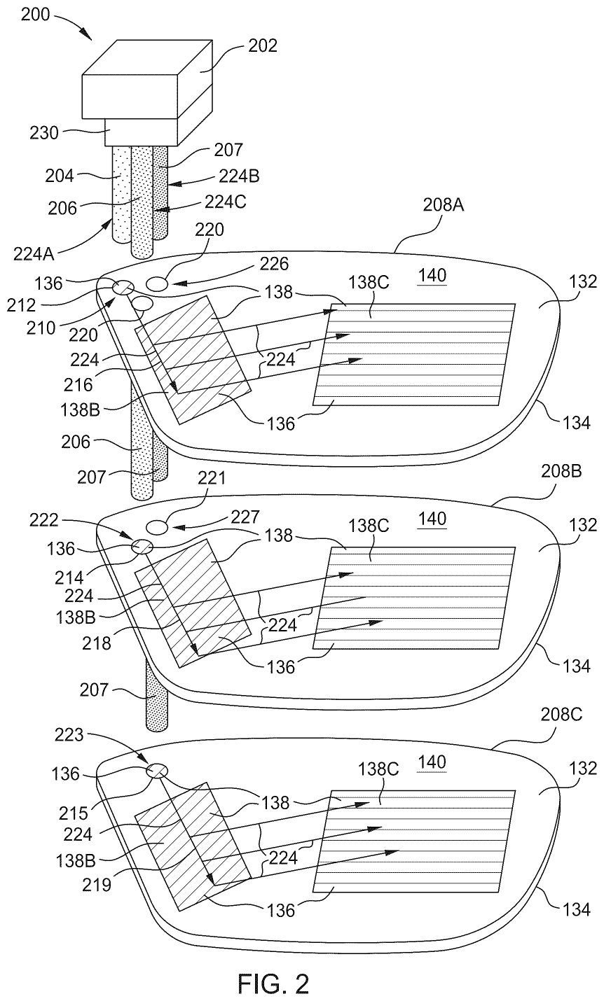

FIG. 2 is a device 200. Device 200 has a light engine 202, a first incident light trajectory 204, a second incident light trajectory 206, a third incident light trajectory 207, a first waveguide 208A, a second waveguide 208B, a third waveguide 208C, a first input coupler 212, a second input coupler 214, a third input coupler 215, a first transmitted light trajectory 216, a second transmitted light trajectory 218, a third transmitted light trajectory 219, a first local anti-reflective coating 220, a second local anti-reflective coating 221, and a pupil 230. The device 200 includes the first waveguide 208A, the second waveguide 208B, and the third waveguide 208C. It is to be understood that each waveguide (e.g., the first waveguide 208A, the second waveguide 208B, or the third waveguide 208C) described herein is an exemplary waveguide and that other waveguides may be used with or modified to accomplish aspects of the present disclosure. Each waveguide (e.g., the first waveguide 208A, the second waveguide 208B, or the third waveguide 208C) may be a waveguide layer. In certain embodiments, a waveguide combiner is formed from the waveguide layers. Each waveguide (e.g., the first waveguide 208A, the second waveguide 208B, or the third waveguide 208C) includes a plurality of structures 136. The structures 136 may be disposed over, under, or on a first surface 132 or a second surface 134 of a substrate 140, or disposed in the substrate 140. The structures 136 are nanostructures that have a sub-micron critical dimension (e.g., less than 1 micrometer). Regions of the structures 136 correspond to one or more gratings 138. In one embodiment, which can be combined with other embodiments described herein, each waveguide (e.g., the first waveguide 108A and the second waveguide 108B) includes at least an input coupler (e.g., a first input coupler 212, a second input coupler 214, or a third input coupler 215) (e.g., an input coupler grating), an output coupler 138C (e.g., an out coupler grating), and an intermediate grating 138B (e.g., a pupil expander or fold grating). Alternatively or additionally, the device 100 includes the structures 136 disposed on one waveguide (e.g., the first waveguide 208A, the second waveguide 208B, or the third waveguide 208C)

In operation, the input coupler (e.g., the first input coupler 112 or the second input coupler 114) receives incident beams of light having an intensity from a light engine 102. The incident beams are split by the structures 136 into T1 beams that have all of the intensity of the incident beams in order to direct a virtual image to the intermediate grating (if utilized) or to the output coupler 138C. In one embodiment, which can be combined with other embodiments described herein, the T1 beams undergo total-internal-reflection (TIR) through the waveguide (e.g., the first waveguide 208A, the second waveguide 208B, or the third waveguide 208C) until the T1 beams come in contact with the structures 136 of the intermediate grating. The structures 136 of the intermediate grating diffract the T1 beams to T−1 beams that undergo TIR through the waveguide (e.g., the first waveguide 208A, the second waveguide 208B, or the third waveguide 208C) to the structures 136 of the output coupler 138C. The structures 136 of the output coupler 138C outcouple the T1 beams to the user's eye. The T1 beams outcoupled to the user's eye display the virtual image produced from the light engine from the user's perspective and further increase the viewing angle from which the user can view the virtual image. In another embodiment, which can be combined with other embodiments described herein, the T1 beams undergo total-internal-reflection (TIR) through the waveguide (e.g., the first waveguide 208A, the second waveguide 208B, or the third waveguide 208C) until the T1 beams come in contact with the structures 136 of the output coupler 138C and are outcoupled to display the virtual image produced from the light engine.

Each waveguide (e.g., the first waveguide 208A, the second waveguide 208B, or the third waveguide 208C) includes an input coupler (e.g., a first input coupler 212, a second input coupler 214, or a third input coupler 215) operable to in-couple light into the waveguide (e.g., the first waveguide 208A, the second waveguide 208B, or the third waveguide 208C) and an output coupler 138C. Each waveguide may be a lens or each waveguide may be disposed over or in a lens. The first input coupler 212 has a first coupler area 210 aligned with the first incident light trajectory 204. The first coupler area 210 is a surface area of the first input coupler 212. The second waveguide 208B has a second input coupler 214 with a second coupler area 222 substantially aligned with the second incident light trajectory 206. The second coupler area 222 is a surface area of the second input coupler 214. The third waveguide 208C has a third input coupler 215 with a third coupler area 223 substantially aligned with the third incident light trajectory 207. The third coupler area 223 is a surface area of the third input coupler 215. In some embodiments, which can be combined with other embodiments described herein, at least one of the waveguides (e.g., the first waveguide 208A, the second waveguide 208B, or the third waveguide 208C) includes an intermediate grating 138B (e.g., a pupil expander).

The first waveguide 208A includes the first local anti-reflective coating 220 substantially aligned with the second incident light trajectory 206 and the third incident light trajectory 207. The first local anti-reflective coating 220 may have a first coating area 226, which may include one or more connected or disconnected portions. The second waveguide 208B includes the second local anti-reflective coating 221 substantially aligned with the third incident light trajectory 207. The second local anti-reflective coating 221 may have a second coating area 227, which may include one or more connected or disconnected portions. The coating areas 226/227 may have variable shape, including a triangle, circle, semi-circle, square, rectangle, parallelogram, rhombus, trapezium, kite, polygon, non-geometric shape, or any other suitable shape. The coating areas 226/227 may have variable size, though the size of coating areas 226/227 may not exceed the size of the waveguides (e.g., the first waveguide 208A, the second waveguide 208B, or the third waveguide 208C) and may not overlap with the first input coupler 212, the first transmitted light trajectory 216, the second input coupler 214, or the second transmitted light trajectory 218. The coatings areas 226/227 have, at a minimum, the same area and shape as the input light at the surface of the device 200.

The device 200 has a light engine 202 which includes a pupil 230 disposed above and aligned with the first input coupler 212 and the first local anti-reflective coating 220. The light engine 202 is operable to project light 224 along the first incident light trajectory 204 from the pupil 230 to first waveguide 208A. The light 224 is projected at a light engine power. The light 224 is a projected image of a red light, a green light, and a blue light, i.e., white light. The light engine power is maintained at all wavelengths of the light 224. The pupil 230 projects the first portion 224A of light 224 with an in-plane area measured at the Z-coordinate of the first input coupler 212. The in-plane area is greater than the first coupler area 210. The first input coupler 212 transmits a first portion 224A of the light 224 corresponding to the first coupler area 210 across the first waveguide 208A along a first transmitted light trajectory 216. The pupil 230 projects the second portion 224B of light 224 with an in-plane area measured at the Z-coordinate of the first local anti-reflective coating 220. The in-plane area is greater than the first coating area 226. The first local anti-reflective coating 220 transmits a second portion 224B of the light 224 corresponding to the first coating area 226 through the first waveguide 208A along a second incident light trajectory 206 to the second waveguide 208B.

The first portion 224A of light 224 is in-coupled by the first input coupler 212 into the first waveguide 208A. The first portion 224A of light 224 is out-coupled by a first output coupler (e.g., output coupler 138C) of the first waveguide 208A. The first portion 224A of light 224 that is out-coupled is overlaid over the user's eye. The first portion 224A of light 224 includes the blue light of the projected image that is out-coupled as a blue field of view (FOV) and the green FOV the displayed image.

The device 200 has the second waveguide 208B. The second waveguide 208B includes the second input coupler 214. The second input coupler 214 has a second coupler area 222. The second coupler area 222 is a surface area of the second input coupler 214. As shown in FIG. 2 in some embodiments, the second input coupler 214 is disposed directly below the light engine 202. In some embodiments, the second portion 224B of the light 224 that passed through the first waveguide 208A has an in-plane area measured at the Z-coordinate of the second input coupler 214 equal to the second coupler area 222. The in-plane area of the light 224 from the pupil 230 measured at the Z-coordinate of the second input coupler 214 is equal to the first coupler area 210 and the second coupler area 222 combined adjusting for any pupil 230 convergence or divergence. The second local anti-reflective coating 221 transmits a third portion 224C of the light 224 corresponding to the second coating area 227 through the second waveguide 208B along a third incident light trajectory 207 to the third waveguide 208C.

The second portion 224B of light 224 is in-coupled by the second input coupler 214 into the second waveguide 208B. The second portion 224B of light 224 is out-coupled by a second output coupler (e.g., output coupler 138C) of the second waveguide 208B. The second portion 224B of light 224 that is out-coupled is overlaid over the user's eye. The second color light includes the green light of the projected image that is out-coupled as a red FOV of the displayed image. The blue FOV, the green FOV, and the red FOV combine to create a total FOV for the displayed image.

The device 200 has the third waveguide 208C. The third waveguide 208C includes the third input coupler 215. The third input coupler 215 has a third coupler area 223. The third coupler area 223 is a surface area of the third input coupler 215. As shown in FIG. 2 in some embodiments, the third input coupler 215 is disposed directly below the light engine 202. In some embodiments, the third portion 224C of the light 224 that passed through the first waveguide 208A and the second waveguide 208B has an in-plane area measured at the Z-coordinate of the third input coupler 215 equal to the third coupler area 223. The in-plane area of the light 224 from the pupil 230 measured at the Z-coordinate of the first input coupler 212 is equal to the first coupler area 210, the second coupler area 222, and the third coupler area 223 combined adjusting for any pupil 230 convergence or divergence.

The third portion 224C of light 224 is in-coupled by the third input coupler 215 into the third waveguide 208C. The third portion 224C of light 224 is out-coupled by a third output coupler (e.g., output coupler 138C) of the third waveguide 208C. The third portion 224C of light 224 that is out-coupled is overlaid over the user's eye. The third color light includes the red light of the projected image that is out-coupled as a red FOV of the displayed image. The blue FOV, the green FOV, and the red FOV combine to create a total FOV for the displayed image.

The first input coupler 212 is offset from the second input coupler 214 and the third input coupler 215 in an X-direction and a Y direction in an X-Y-Z coordinate system. The second input coupler 214 is offset from the first input coupler 212 and the third input coupler 215 in an X-direction and a Y direction in an X-Y-Z coordinate system. The first anti-reflective coating 220 has the same center point X-coordinate on an X-axis of the X-Y-Z coordinate system and center point Y-coordinate on a Y-axis of the X-Y-Z coordinate system as the second input coupler 214 and the third input coupler 215. The second anti-reflective coating 221 has the same center point X-coordinate on an X-axis of the X-Y-Z coordinate system and center point Y-coordinate on a Y-axis of the X-Y-Z coordinate system as the third input coupler 215. The positioning of the input couplers and anti-reflective coatings allow the second portion 224B of light 224 and the third portion 224C of light 224 to be transmitted to the second input coupler 214 and the third input coupler 215 at a desired intensity.

The blue and the green FOV and the red FOV are projected having an optimized color uniformity and efficiency. In some embodiments, the device 200 is in an AR device and the blue FOV, the green FOV and the red FOV are projected in the AR device. The blue FOV, the green FOV, and the red FOV can be combined in an image that has optimized uniformity of Red-Blue-Green (RGB) color across the FOV. The blue FOV, the green FOV, and the red FOV may be configurable such that the blue FOV may be disposed on any of the lenses 208, the green FOV may be disposed on any of the lenses 208, and red FOV may be disposed on any of the lenses 208.

In some cases, anti-reflective coatings may increase light transmitted to through an interface and reduce reflections. Anti-reflective coating may have a quarter-wavelength thickness (t_{AR}) and a refractive index (N_{AR}) that is the geometric mean of the surrounding media. The t_{AR} may be equal to

$$( \frac{λ}{4 * n A R} ) ,$$

where λ is the wavelength of light through a medium and n_{AR} is the refractive index of the anti-reflective coating. Anti-reflective coating materials may include polymer, epoxy, SiOₓ, SiNₓ, some combination therein, or any other suitable material. Anti-reflective coatings may be deposited onto the surface of a substrate using physical vapor deposition (PVD), chemical vapor deposition (CVD), flowable CVD (FCVD), inkjet, or any other suitable method for deposition. In some cases, anti-reflective coatings are utilized for high index multi-sheet substrate gratings with properties that facilitate low light transmission through a substrate material.

In some embodiments, the local anti-reflective coating is deposited on the grating side of a substrate. In some embodiments, a local or global anti-reflective coating is compatible on the non-grating side. In some embodiments, the front and backside anti-reflective coatings can be different thicknesses and materials to best suit the material interfaces. Local anti-reflective coatings may increase light transmitted to lower sheet input couplers in a lens stack, increasing overall efficiency. In some cases, local anti-reflective coatings do not intersect the in-plane pupil path to preserve the modulation transfer function (MTF). The local anti-reflective coatings must have at least an area/shape equal to the beam size at that sheet, but may be larger.

While the foregoing is directed to embodiments of the present disclosure, other and further embodiments of the disclosure may be devised without departing from the basic scope thereof, and the scope thereof is determined by the claims that follow.

What is claimed is:

1. A device, comprising:
a first waveguide, the first waveguide comprising:
a first input coupler operable to receive a first color light and in-couple the first color light into the first waveguide; and
a coating area adjacent to a grating of the first input coupler, the coating area operable to receive a second color light, the coating area having an anti-reflective coating with a transmission refractive index such that in operation the second color light is transmitted through the first waveguide to a second waveguide; and
the second waveguide below the first waveguide, the second waveguide having a second input coupler disposed below and aligned with the coating area, the second input coupler operable to receive the second color light and in-couple the second color light into the second waveguide.

2. The device of claim 1, wherein the first waveguide has an output coupler to out-couple a blue field of view (FOV) and a green FOV from the first color light that is in-coupled.

3. The device of claim 1, wherein the device further comprises an output coupler to out-couple a red field of view (FOV) from the second color light that is in-coupled.

4. The device of claim 1, further comprising a light engine disposed above the first waveguide with a pupil above the first input coupler.

5. The device of claim 1, wherein the anti-reflective coating is disposed over a first surface of the first waveguide opposing a second surface, under the second surface, or both over and under the second surface.

6. The device of claim 1, wherein the first input coupler is operable to in-couple the first color light into the first waveguide.

7. The device of claim 1, wherein the second input coupler is operable to in-couple the second color light into the first waveguide.

8. The device of claim 1, wherein the anti-reflective coating has a thickness, the thickness being equal to a quarter-wavelength thickness value associated with a material.

9. The device of claim 1, wherein the transmission refractive index is a mean of a refractive index of a first material of the first waveguide and a second material between the coating area and the first input coupler.

10. A device, comprising:
a first waveguide, the first waveguide having:
a first input coupler operable to receive a first color light and in-couple the first color light into the first waveguide; and
a first coating area adjacent to a first grating of the first input coupler, the first coating area operable to receive a second color light and a third color light, the first coating area having a first anti-reflective coating with a first transmission refractive index such that in operation the second color light is transmitted through the first waveguide to a second waveguide, and the first coating area having a second anti-reflective coating with a second transmission refractive index such that in operation the third color light is transmitted through the first waveguide to the second waveguide;
the second waveguide, the second waveguide having:
a second input coupler operable to receive the second color light and in-couple the second color light into the second waveguide; and
a second coating area adjacent to a second grating of the second input coupler, the second coating area operable to receive the third color light, the second coating area having a third anti-reflective coating with a third transmission refractive index such that in operation the third color light is transmitted through the second waveguide to a third waveguide; and
the third waveguide below the second waveguide, the third waveguide having a third input coupler disposed below and aligned with the second coating area, the third input coupler operable to receive the third color light and in-couple the third color light into the third waveguide.

11. The device of claim 10, wherein the device further comprises an output coupler to out-couple a blue field of view (FOV).

12. The device of claim 10, wherein the device further comprises an output coupler to out-couple a green field of view (FOV).

13. The device of claim 10, wherein the device further comprises an output coupler to out-couple a red field of view (FOV).

14. The device of claim 10, further comprising a light engine disposed above the first waveguide with a pupil above the first input coupler.

15. The device of claim 10, wherein the first anti-reflective coating is disposed over a first surface of the first waveguide opposing a second surface of the first waveguide, under the second surface, or both over and under the second surface, and the second anti-reflective coating is disposed over a third surface of the second waveguide opposing a fourth surface of the second waveguide, under the third surface, or both over and under the third surface.

16. The device of claim 10, wherein the first input coupler is operable to in-couple the first color light into the first waveguide.

17. The device of claim 10, wherein the second input coupler is operable to in-couple only the second color light into the first waveguide.

18. The device of claim 10, wherein the first anti-reflective coating, the second anti-reflective coating, and the third anti-reflective coating have a thickness, the thickness being equal to a quarter-wavelength thickness value associated with a material.

19. The device of claim 10, wherein the first transmission refractive index is a first mean of a first refractive index of a first material of the first waveguide and a second material between the first coating area and the first input coupler, the second transmission refractive index is a second mean of a second refractive index of the first material of the first waveguide and a third material between the second coating area and the first input coupler, and the third transmission refractive index is a third mean of a third refractive index of a fourth material of the second waveguide and a fifth material between the second coating area and the second input coupler.

20. A method for using a device, comprising:
in-coupling a first color light into a first waveguide, the first waveguide having a first input coupler operable to receive the first color light; and
receiving a second color light at a coating area adjacent to a grating of the first input coupler, the coating area having an anti-reflective coating with a transmission refractive index such that in operation the second color light is transmitted through the first waveguide to a second waveguide, the second waveguide below the first waveguide, the second waveguide having a second input coupler disposed below and aligned with the coating area, the second input coupler operable to receive the second color light and in-couple the second color light into the second waveguide.
